(19) United States
(12) Patent Application Publication
(10) Pub. No.: US 2019/0143568 A1
(43) Pub. Date: May 16, 2019

(54) METHOD FOR MANUFACTURING VEHICLE DOOR MOLDING

(71) Applicant: SHIROKI CORPORATION, Fujisawa-shi (JP)

(72) Inventors: Toshiji Itou, Fujisawa-shi (JP); Shigeharu Matsuyama, Fujisawa-shi (JP); Yusuke Murase, Anjo-shi (JP); Shingo Hanano, Kariya-shi (JP); Kanehiro Nagata, Kariya-shi (JP)

(73) Assignee: SHIROKI CORPORATION, Fujisawa-shi (JP)

(21) Appl. No.: 16/184,316

(22) Filed: Nov. 8, 2018

(30) Foreign Application Priority Data
Nov. 14, 2017 (JP) 2017-218824

(51) Int. Cl. B29C 43/28; B29C 43/48

(52) U.S. Cl. CPC B29C 43/28; B29K 2023/12; B29C 2043/486; B29C 43/48

(57) ABSTRACT

A vehicle door molding includes a core member and a resin material. The resin material includes a curved surface as viewed in a cross section orthogonal to a longitudinal direction of the vehicle door molding. A method for manufacturing the vehicle door molding includes covering a surface of the resin material with a film during transfer of the core member on which the resin material is disposed. The method further includes pressing an entire surface of the film with pressing members during transfer of the core member on which the resin material is disposed. The pressing is performed following the covering with the film. The pressing members are arranged at positions differing from each other in a transfer direction and a direction intersecting with the transfer direction. The method further includes separating the film from the resin material after the pressing.

### BACKGROUND ART

The present invention relates to a method for manufacturing a vehicle door molding.

A structure in which molding formed of metal such as stainless steel or aluminum (hereafter, referred to as door molding) is attached to a vehicle door is conventional. Door molding covers a joint portion of a door panel to improve the design of a vehicle door.

For example, Japanese Patent No. 3243817 describes a method for manufacturing a vehicle door molding. In the method, after a resin material is disposed on the surface of a stainless molding, the surface of the resin material is covered with a film. Then, the surface of the resin material is pushed by an extrusion die via the film. Subsequently, the film is separated from the surface of the resin material. This flattens the surface of the resin material. Thus, the design of the vehicle door molding is improved.

However, in the method for manufacturing a vehicle door molding described above, when a stainless molding is bent in the longitudinal direction, it is difficult to smooth the resin material disposed on the bent part of the stainless molding with the extrusion die. Thus, there is room for improvement in the design of a vehicle door molding.

### SUMMARY OF THE INVENTION

It is an object of the present invention to provide a method for manufacturing a vehicle door molding that improves the design of the vehicle door molding having a curved surface as viewed in a cross section orthogonal to a longitudinal direction.

According to one aspect of the present invention, a vehicle door molding includes a core member and a resin material disposed on a surface of the core member. The resin material includes a curved surface as viewed in a cross section orthogonal to a longitudinal direction of the vehicle door molding. A method for manufacturing the vehicle door molding includes covering a surface of the resin material with a film during transfer of the core member on which the resin material is disposed. The method further includes pressing an entire surface of the film with pressing members during transfer of the core member on which the resin material is disposed. The pressing is performed following the covering with the film. The pressing members are arranged at positions differing from each other in a transfer direction and a direction intersecting with the transfer direction. The method further includes separating the film from the resin material after the pressing.

### BRIEF DESCRIPTION OF THE DRAWINGS

FIG. 1 is a side view of a vehicle to which a door molding is attached according to the present invention.

FIG. 2 is a cross-sectional view taken along line A-A in FIG. 1.

FIG. 3 is a cross-sectional view of a belt molding according to the present invention.

FIG. 4 is a schematic diagram showing the structure of a device that manufactures a vehicle door molding.

FIGS. 5A to 5E are schematic diagrams showing the process for manufacturing a belt molding in a first embodiment.

FIGS. 6A to 6E are schematic diagrams showing the process for manufacturing a belt molding in a second embodiment.

### DESCRIPTION OF THE EMBODIMENTS

### First Embodiment

A first embodiment of the present invention will now be described with reference to the drawings.

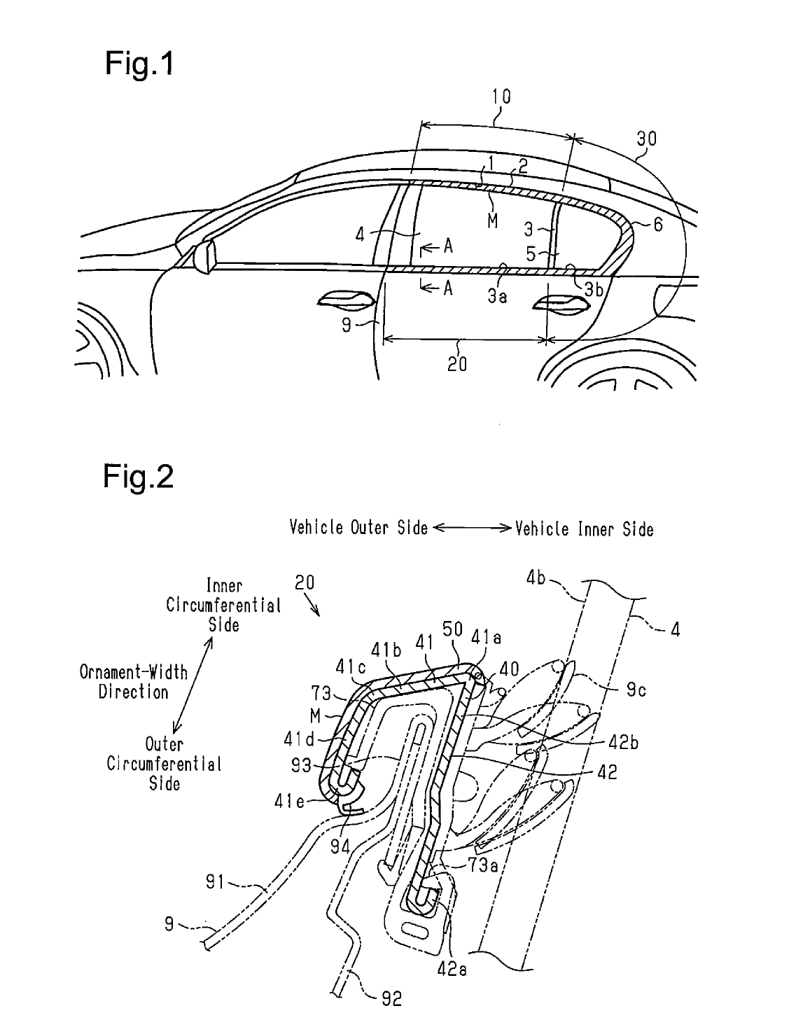

As shown in FIG. 1, the rear part of a vehicle includes a rear door 2 serving as a vehicle door that opens and closes an entrance 1 to allow a passenger to get into and out of the vehicle from the rear seat side. The upper part of the rear door 2 includes openings 3a and 3b defined in a front-rear direction by a division bar 3 extending in a vertical direction. The first opening 3a located frontward from the division bar 3 is opened or closed by a movable glass 4 (hereafter, referred to as window glass). The second opening 3b located rearward from the division bar 3 is closed by a fixed glass 5. The rear door 2 has an outer side surface provided with a vehicle door molding (hereafter, referred to as door molding 6) having an ornamental surface M continuously defining the openings 3a and 3b.

The door molding 6 includes a frame molding 10 located above the first opening 3a and a belt molding 20 located below the first opening 3a. The door molding 6 further includes a rear molding 30 extending along the second opening 3b and connecting the frame molding 10 and the belt molding 20. The door molding 6 includes the frame molding 10, the belt molding 20, and the rear molding 30 that are integrally formed. The ornamental surface M of the door molding 6 is U-shaped and open frontward. In the description hereafter, the width-wise direction of the ornamental surface M extending along the openings 3a and 3b is referred to as an ornament-width direction. Additionally, in each of the molding portions 10, 20, and 30 of the door molding 6, the side closer to the opening is referred to as an inner circumferential side, and the side opposite to the open side is referred to as an outer circumferential side.

The belt molding 20 will now be described.

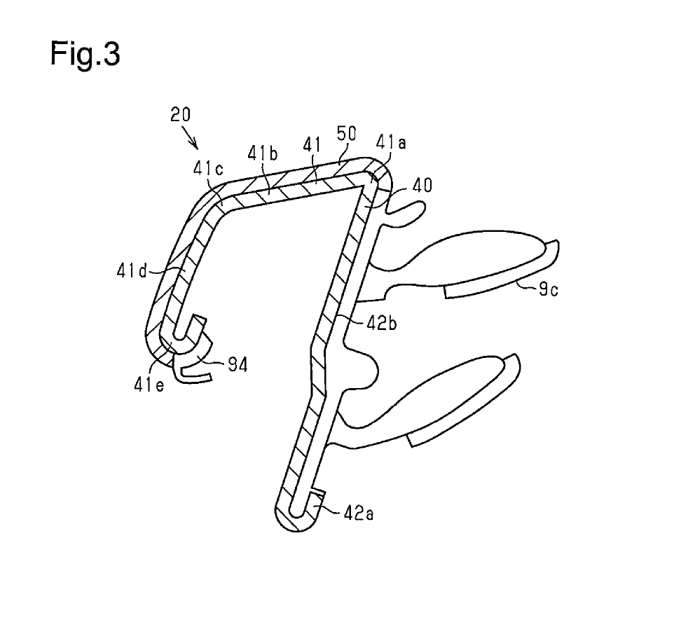

As shown in FIGS. 2 and 3, the belt molding 20 includes a core member 40 bent in the longitudinal direction and a resin material 50 disposed on the surface of the core member 40. The core member 40 includes an exterior portion 41 located at a vehicle outer side of a door panel 9 and a rail portion 42 located at a vehicle inner side of the door panel 9. The core member 40 has an inverted U-shaped cross section. The material of the core member 40 may be a metal material such as SUS (stainless steel) or may be a resin material such as polypropylene.

The exterior portion 41 includes a first bent part 41a bent from an upper end of the rail portion 42 toward the vehicle outer side, a first planar straight part 41b extending from an end of the first bent part 41a toward the vehicle outer side, a second bent part 41c bent from an end of the first straight part 41b toward the outer circumferential side in the ornament-width direction of the door panel 9, a second planar straight part 41d extending from an end of the second bent part 41c along a joint portion 93 of an outer panel 91 and an inner panel 92 that are included in the door panel 9, and a third bent part 41e bent from an end of the second straight part 41d toward the vehicle inner side. The resin material 50 is disposed on the surface of the exterior portion 41. The surface of the resin material 50 defines a portion of the ornamental surface M of the door molding 6 extending below the first opening 3a. A cover member 94 adheres to an end of the third bent part 41e of the exterior portion 41 to close the gap between the core member 40 and the outer panel 91. The rail portion 42 is planar and has a thickness-wise direction that is substantially orthogonal to an outer surface 4b of the window glass 4. The belt molding 20 is attached to cover an upper end of the door panel 9.

The rail portion 42 includes a lip engagement part 42a to which a lip 9c is fixed to wipe the outer surface 4b of the window glass 4. The lip 9c is formed integrally with a clip 73 hooked on the joint portion 93 of the door panel 9. The lip 9c includes a hook 73a engaged with the lip engagement part 42a of the rail portion 42. When the hook 73a is engaged with the lip engagement part 42a and attached to a surface 42b of the rail portion 42 located at the vehicle inner side, the lip 9c is fixed at the vehicle inner side of the door panel 9.

A manufacturing device 100 manufacturing the belt molding 20 by forming the surface of the resin material 50 on the belt molding 20 will now be described.

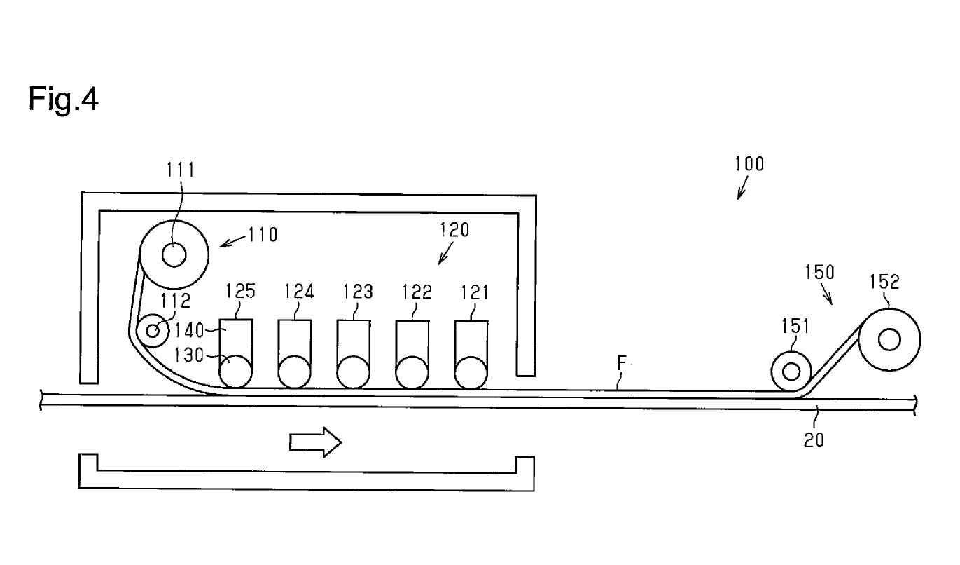

As shown in FIG. 4, the manufacturing device 100 includes a cover unit 110, a pressing unit 120, and a separation unit 150.

The cover unit 110 includes a feeding roller 111 on which an elongated film F is wound. The feeding roller 111 is driven to rotate so that the film F is fed from the feeding roller 111. A tension roller 112 is arranged at a position adjacent to the feeding roller 111. Thus, the film F is fed from the feeding roller 111 to the pressing unit 120 under tension applied by the tension roller 112.

The pressing unit 120 includes a plurality of (five in the present embodiment) pressing members 121 to 125. Each of the pressing members 121 to 125 includes a roller 130 rolling in contact with the film F and a driver 140 moving the roller 130 vertically and horizontally. In the present embodiment, the pressing members 121 to 125 are arranged in correspondence with each part of the curved surface of the exterior portion 41 and include a first pressing member 121 corresponding to the third bent part 41e, a second pressing member 122 corresponding to the second straight part 41d, a third pressing member 123 corresponding to the second bent part 41c, a fourth pressing member 124 corresponding to the first straight part 41b, and a fifth pressing member 125 corresponding to the first bent part 41a. In the present embodiment, the first pressing member 121, the second pressing member 122, the third pressing member 123, the fourth pressing member 124, and the fifth pressing member 125 are sequentially arranged from the downstream side in a direction in which the film F is fed from the feeding roller 111. In other words, the pressing members 121 to 125 differ from each other in position in a direction in which the core member 40 is transferred. Regions of the curved surface of the core member 40 that are pressed by adjacent ones of the pressing members 121 to 125 partially overlap with each other.

Under the pressing unit 120, the belt molding 20 is transferred in the longitudinal direction of the belt molding 20 with the exterior portion 41, which is the part of the core member 40 subject to smoothing, faced upward. At this time, the belt molding 20 is transferred so that the second bent part 41c of the exterior portion 41 defines a top surface.

The rollers 130 are formed from a soft material and elastically deform when the rollers 130 bring the film F into tight contact with the surface of the resin material 50 disposed on the exterior portion 41. The rollers 130 are curved and bulged in the pressing direction before pressing the film F. This increases the tightness of contact of the rollers 130 with the film F. The drivers 140 adjust relative positions of the rollers 130 to the exterior portion 41 and bring the rollers 130 into tight contact with the film F. The drivers 140 also adjust angles of the pressing members 121 to 125 to change directions in which the rollers 130 press the film F against the exterior portion 41.

The separation unit 150 includes a separation roller 151 and a winding roller 152. The separation roller 151 separates the film F, which is in tight contact with the surface of the resin material 50, from the resin material 50. The winding roller 152 winds the film F separated from the surface of the resin material 50 by the separation roller 151. At this time, the outer appearance of the surface of the resin material 50 does not change between before and after the separation of the film F. Thus, when the rollers 130 press and smooth the surface of the resin material 50 via the film F, and then the film F is separated, the resin material 50 maintains a smooth surface. As a result, the belt molding 20 obtains the shiny exterior portion 41, serving as the ornamental surface M. This improves the design of the belt molding 20.

The operation of the manufacturing device 100 of the present embodiment will now be described.

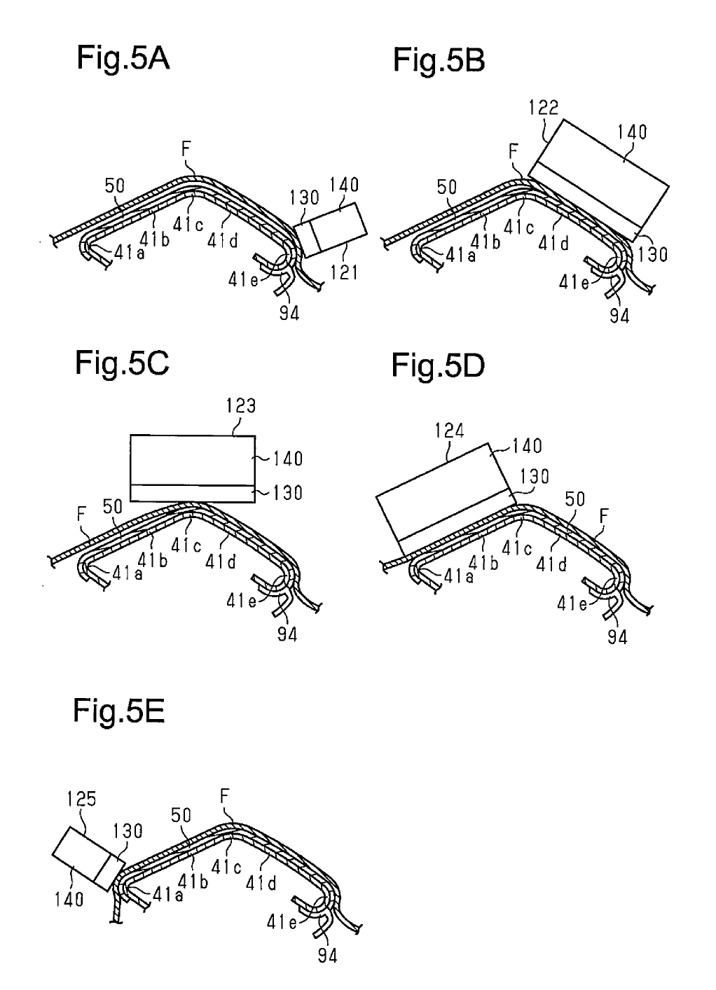

As shown in FIG. 5A, when smoothing the surface of the resin material 50 disposed on the exterior portion 41, the third bent part 41e and the first pressing member 121 are opposed to each other with the film F located in between. The first pressing member 121 presses the surface of the resin material 50 disposed on the third bent part 41e via the film F. At this time, the first pressing member 121 presses the film F covering the third bent part 41e to bring the film F into tight contact with the surface of the resin material 50 and smooth the surface of the resin material 50.

As shown in FIG. 5B, the second straight part 41d, which is located adjacent to the third bent part 41e, and the second pressing member 122 are opposed to each other with the film F located in between. The second pressing member 122 presses the surface of the resin material 50 disposed on the second straight part 41d via the film F. At this time, the second pressing member 122 presses the film F covering the second straight part 41d to bring the film F into tight contact with the surface of the resin material 50 and smooth the surface of the resin material 50.

As shown in FIG. 5C, the second bent part 41c, which is located adjacent to the second straight part 41d, and the third pressing member 123 are opposed to each other with the film F located in between. The third pressing member 123 presses the surface of the resin material 50 disposed on the second bent part 41c via the film F. At this time, the third pressing member 123 presses the film F covering the second bent part 41c to bring the film F into tight contact with the surface of the resin material 50 and smooth the surface of the resin material 50.

As shown in FIG. 5D, the first straight part 41b, which is located adjacent to the second bent part 41c, and the fourth pressing member 124 are opposed to each other with the film F located in between. The fourth pressing member 124 presses the surface of the resin material 50 disposed on the first straight part 41b via the film F. At this time, the fourth pressing member 124 presses the film F covering the first straight part 41b to bring the film F into tight contact with the surface of the resin material 50 and smooth the surface of the resin material 50.

As shown in FIG. 5E, the first bent part 41a, which is located adjacent to the first straight part 41b, and the fifth pressing member 125 are opposed to each other with the film F located in between. The fifth pressing member 125 presses the surface of the resin material 50 disposed on the first bent part 41a via the film F. At this time, the fifth pressing member 125 presses the film F covering the first bent part 41a to bring the film F into tight contact with the surface of the resin material 50 and smooth the surface of the resin material 50.

In the present embodiment, when covering the surface of the resin material 50 disposed on the exterior portion 41, the film F sequentially comes into contact with adjacent parts of the curved surface of the exterior portion 41. This limits formation of voids between the surface of the resin material 50 and the film F and appropriately smooths the surface of the resin material 50.

The first embodiment has the advantages described below.

(1) In the present embodiment, the pressing unit 120 presses the film F against the curved surface of the core member 40 with the pressing members 121 to 125 to smooth the surface of the resin material 50. Thus, the resin material 50 disposed on the curved surface of the core member 40 is appropriately smoothed. This improves the design of a vehicle door molding having a curved surface as viewed in a cross section orthogonal to a longitudinal direction.

(2) In the present embodiment, the pressing unit 120 presses a predetermined curved part of the curved surface of the core member 40 and then a curved part that is adjacent to the predetermined curved part before pressing a curved part that is not adjacent to the predetermined curved part. That is, the pressing unit 120 presses the surface of the resin material 50 in order from adjacent curved parts of the curved surface of the core member 40. This limits formation of creases in the film F pressing the surface of the resin material 50 even when the resin material 50 is bent due to application of gravity force. Thus, the surface of the resin material 50 is appropriately smoothed.

(3) In the present embodiment, regions of the curved surface of the core member 40 that are pressed by adjacent ones of the pressing members 121 to 125 partially overlap with each other. This further limits formation of creases in the film F when adjacent ones of the pressing members 121 to 125 press the surface of the resin material 50. The surface of the resin material 50 is further appropriately smoothed.

(4) In the present embodiment, at least the ends of the pressing members 121 to 125 contacting the film F are formed from a soft material. This increases the tightness of contact of the pressing members 121 to 125 with the film F. The resin material 50 disposed on the curved surface of the core member 40 is further appropriately smoothed.

### Second Embodiment

A second embodiment of the present invention will now be described. The second embodiment differs from the first embodiment in the order of pressing the surface of the resin material disposed on the exterior portion. The description will focus on the differences from the first embodiment. Elements that are the same as or correspond to those of the first embodiment will not be described in detail.

In the present embodiment of the manufacturing device 100, the third pressing member 123, the fourth pressing member 124, the fifth pressing member 125, the second pressing member 122, and the first pressing member 121 are sequentially arranged from the downstream side in the feeding direction of the film F from the feeding roller 111.

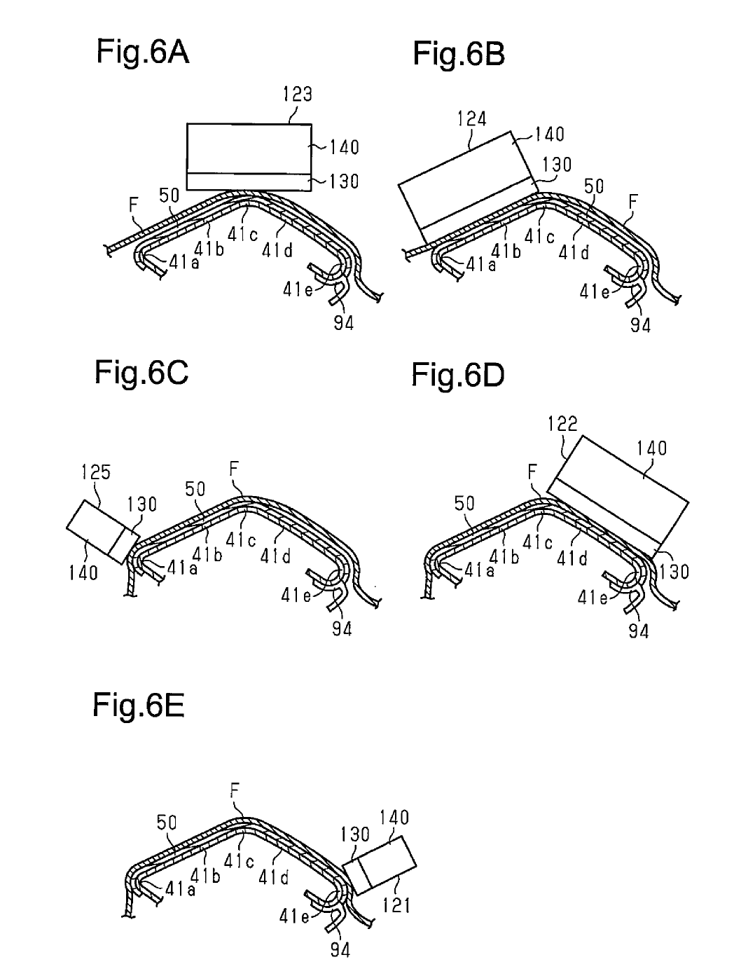

As shown in FIG. 6A, when smoothing the surface of the resin material 50 disposed on the exterior portion 41, the second bent part 41c, defining the top surface of the exterior portion 41, and the third pressing member 123 are opposed to each other with the film F located in between. The third pressing member 123 presses the surface of the resin material 50 disposed on the second bent part 41c via the film F. At this time, the third pressing member 123 presses the film F covering the second bent part 41c to bring the film F into tight contact with the surface of the resin material 50 and smooth the surface of the resin material 50.

As shown in FIG. 6B, the first straight part 41b, which is located adjacent to the second bent part 41c, and the fourth pressing member 124 are opposed to each other with the film F located in between. The fourth pressing member 124 presses the surface of the resin material 50 disposed on the first straight part 41b via the film F. At this time, the fourth pressing member 124 presses the film F covering the first straight part 41b to bring the film F into tight contact with the surface of the resin material 50 and smooth the surface of the resin material 50.

As shown in FIG. 6C, the first bent part 41a, which is located adjacent to the first straight part 41b, and the fifth pressing member 125 are opposed to each other with the film F located in between. The fifth pressing member 125 presses the surface of the resin material 50 disposed on the first bent part 41a via the film F. At this time, the fifth pressing member 125 presses the film F covering the first bent part 41a to bring the film F into tight contact with the surface of the resin material 50 and smooth the surface of the resin material 50.

As shown in FIG. 6D, the second straight part 41d, which is located adjacent to the second bent part 41c, and the second pressing member 122 are opposed to each other with the film F located in between. The second pressing member 122 presses the surface of the resin material 50 disposed on the second straight part 41d via the film F. At this time, the second pressing member 122 presses the film F covering the second straight part 41d to bring the film F into tight contact with the surface of the resin material 50 and smooth the surface of the resin material 50.

As shown in FIG. 6E, the third bent part 41e, which is located adjacent to the second straight part 41d, and the first pressing member 121 are opposed to each other with the film F located in between. The first pressing member 121 presses the surface of the resin material 50 disposed on the third bent part 41e via the film F. At this time, the first pressing member 121 presses the film F covering the third bent part 41e to bring the film F into tight contact with the surface of the resin material 50 and smooth the surface of the resin material 50.

As described above, in the present embodiment, when covering the surface of the resin material 50 disposed on the exterior portion 41, the film F sequentially comes into tight contact with adjacent parts of the curved surface of the exterior portion 41. This limits formation of voids between the surface of the resin material 50 and the film F and appropriately smooths the surface of the resin material 50.

The second embodiment has the advantages (1) to (4) described above.

The embodiments described above may be modified as follows.

In the above embodiments, the resin material 50 disposed on the exterior portion 41 does not necessarily have to be smoothed in order from adjacent positions in one direction. For example, the surface of the resin material 50 disposed on the second bent part 41c may first be smoothed, and the surface of the resin material 50 disposed on the second straight part 41d may be smoothed. Then the surface of the resin material 50 disposed on the first straight part 41b, which is located at a side of the second bent part 41c opposite to the second straight part 41d, may be smoothed. Alternatively, the surface of the resin material 50 disposed on the second bent part 41c may first be smoothed, and the surface of the resin material 50 disposed on the first straight part 41b may be smoothed. Then, the surface of the resin material 50 disposed on the second straight part 41d, which is located at a side of the second bent part 41c opposite to the first straight part 41b, may be smoothed.

In the above embodiments, in a process for transferring the belt molding 20, inclination angles of the pressing members 121 to 125 of the pressing unit 120 may be changed. In this case, different parts of the curved surface of the exterior portion 41 may be pressed by a common pressing member.

In the above embodiments, the drivers 140 may be omitted from the pressing members 121 to 125 of the pressing unit 120. In this case, for example, a direction in which each of the pressing members 121 to 125 presses the film F may be predetermined, and the rollers 130 may be urged by, for example, coil springs in the pressing direction. This configures the pressing members 121 to 125 that bring the film F into tight contact with the exterior portion 41 as the pressing members 121 to 125 move in conformance with the curved surface of the exterior portion 41.

The present invention is applicable to the frame molding 10 or the rear molding 30. More specifically, the present invention is applicable to a part including an elongated core member having a curved surface as viewed in a cross section orthogonal to a longitudinal direction.

1. A method for manufacturing a vehicle door molding, wherein the vehicle door molding includes a core member and a resin material disposed on a surface of the core member and the resin material includes a curved surface as viewed in a cross section orthogonal to a longitudinal direction of the vehicle door molding, the method, comprising:
covering a surface of the resin material with a film during transfer of the core member on which the resin material is disposed;
pressing an entire surface of the film with pressing members during transfer of the core member on which the resin material is disposed, wherein the pressing is performed following the covering with the film, and the pressing members are arranged at positions differing from each other in a transfer direction and a direction intersecting with the transfer direction; and
separating the film from the resin material after the pressing.

2. The method according to claim 1, wherein in the pressing, after a predetermined curved part of the curved surface is pressed, a curved part that is adjacent to the predetermined curved part is pressed before a curved part that is not adjacent to the predetermined curved part is pressed.

3. The method according to claim 1, wherein in the pressing, regions of the curved surface that are pressed by adjacent ones of the pressing members partially overlap with each other.

4. The method according to claim 1, wherein
each of the pressing members has an end configured to contact the film, and
at least the end of the pressing member includes a soft material.
